(19) United States
(12) Patent Application Publication
(10) Pub. No.: US 2007/0267147 A1
(43) Pub. Date: Nov. 22, 2007

(54) Signsaver

(76) Inventor: David Wayne Boyes, Mission (CA)

Correspondence Address: DAVID WAYNE BOYES, 8086 CEDAR ST, MISSION, BC, V2U 3N3, CA

(21) Appl. No.: 11/348,914

(22) Filed: Apr. 24, 2006

(51) Int. Cl. B32B 37/00

(52) U.S. Cl. 156/510

(57) ABSTRACT

A plastic device having a “U” shape which will slip over a sign. The ends of the “U” shape device have enough spring tension to hold the sign firmly in place. The sides of the plastic device permits a sticker to be placed on the plastic device rather than directly onto the sign. Upon removal of the plastic device there is no damage caused to the sign from the plastic device.

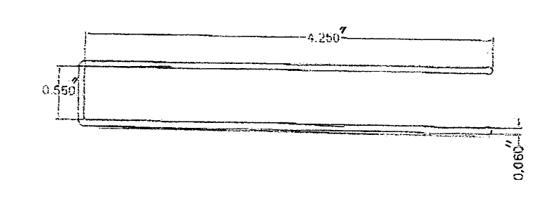

### SPECIFICATIONS

1. The General Character

This invention relates to avoiding sticking a sold sticker directly onto for sale signs.

2. The Nature in General

Slips over for sale sign edge and holds on with spring tension in plastic sides of signsaver.

3. I have found that these disadvantages may be overcome. The for sale sign is destroyed when the sold stickers are removed. This renders the sign unreadable.

4. Best Way to Use Signsaver

Stick the sold stickers onto signsaver on each side then clip onto for sale sign.

5. Drawing shows edge view of signsaver only. “U” shape measurements are 05.5″ deep 4.25″ wide. The length will be 12.5″ This will be made by extrusion mold. This is why drawing is of edge view only.

What is claimed is:

1. A device for attaching decals comprising of a plastic device with a square U shape design with enough length for attaching a decal.

2. The spring tension built into the sides of the U shape allows device to firmly hold onto the sign.

3. The length allows a decal to be affixed to each side of the device.

4. This eliminates applying decals directly onto signs.
